(19) United States
(12) Patent Application Publication
(10) Pub. No.: US 2010/0078485 A1
(43) Pub. Date: Apr. 1, 2010

(54) SUBSCRIBER IDENTITY MODULE CARD

(75) Inventor: Hung Yun LI, TaoYuan (TW)

Correspondence Address: RABIN & Berdo, PC, 1101 14TH STREET, NW, SUITE 500, WASHINGTON, DC, 20005, US

(73) Assignee: DYNACARD CO., LTD., Taipei (TW)

(21) Appl. No.: 12/240,106

(22) Filed: Sep. 29, 2008

(51) Int. Cl. G06K 19/067

(52) U.S. Cl. 235/492

(57) ABSTRACT

A subscriber identity module (SIM) card in accordance with the present invention expands memory, communicates wirelessly, is inserted and removed easily, adds a second cell phone number and comprises a carrier, a SIM, an expansion module. The carrier is a plastic card and comprises an expansion module recess. The plastic card has a top surface, two side edges, a front end, a rear end and two notches. The expansion module recess is formed in the top surface of the plastic card between the side edges near the front end. The SIM is mounted on the top surface of the plastic card near the rear end between the notches. The expansion module is mounted in the expansion module recess, is connected to the SIM and has a top surface, a bottom surface and four edges.

### FIELD OF THE INVENTION

A subscriber identity module (SIM) card in accordance with the present invention is an integrated circuit card that has expanded memory, communicates wirelessly, is inserted and removed easily and allows the cell phone to receive calls on either of two cell phone numbers.

### BACKGROUND OF THE INVENTION

With reference to FIG. 1, a conventional subscriber identity module (SIM) card (2) is an integrated circuit card, is used in Global System for Mobile communications (GSM) mobile phone systems and comprises a carrier (20) and a SIM (21).

The carrier (20) is plastic but does not have any feature to facilitate inserting or removing the conventional SIM card (2).

The SIM (21) is mounted on the carrier (20), has multiple terminals, stores a user's information and transmits information at frequencies of 900 Hz, 1800 Hz or 1900 Hz through a cell phone antenna when the terminals of the SIM contact terminals of the cell phone. However, conventional SIM cards (2) cannot be used with electronic devices that operate at other frequencies.

With use of digital data increasing, memory on conventional SIM cards (2) is limiting use of the SIM cards (2), and SIM card manufacturers are eager to expand memory conventional SIM cards (2).

### SUMMARY OF THE INVENTION

The objective of the present invention is to expand subscriber identity module (SIM) card memory and make SIM cards capable of communicating wirelessly, being inserted and removed easily and receiving calls on either of two cell phone numbers.

A subscriber identity module (SIM) card in accordance with the present invention comprises a carrier, a SIM and an expansion module. The carrier is a plastic card and comprises an expansion module. The plastic card has a top surface, two side edges, a front end, a rear end and two notches. The expansion module is formed in the top surface of the plastic card between the side edges near the front end. The SIM is mounted on the top surface of the plastic card near the rear end. The expansion module is mounted in the expansion module recess, is connected to the SIM and has a top surface, a bottom surface and four edges.

### BRIEF DESCRIPTION OF THE DRAWINGS

FIG. 1 is a perspective view of a conventional SIM card.

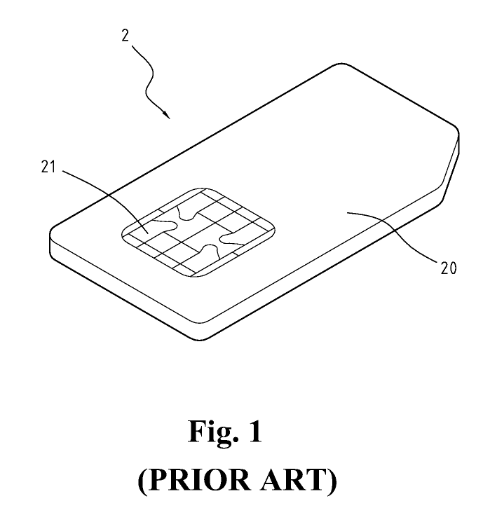

FIG. 2 is a perspective view of a first embodiment of the SIM card in accordance with the present invention.

FIG. 3 is an exploded perspective view of the first embodiment of the SIM card in FIG. 2.

FIG. 4 is a cross sectional side view of a second embodiment of the SIM card in accordance with the present invention.

FIG. 5 is a cross sectional side view of a third embodiment of the SIM card in accordance with the present invention.

### DETAILED DESCRIPTION OF THE PRESENT INVENTION

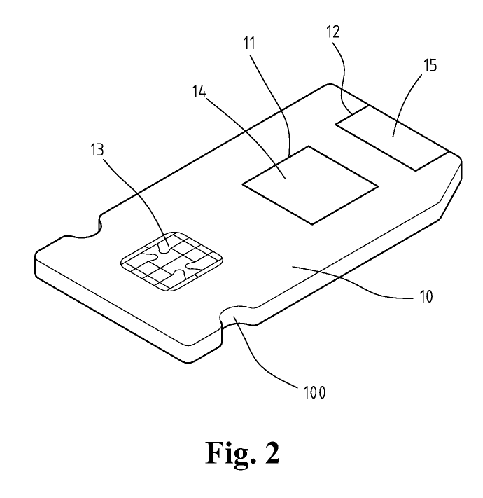

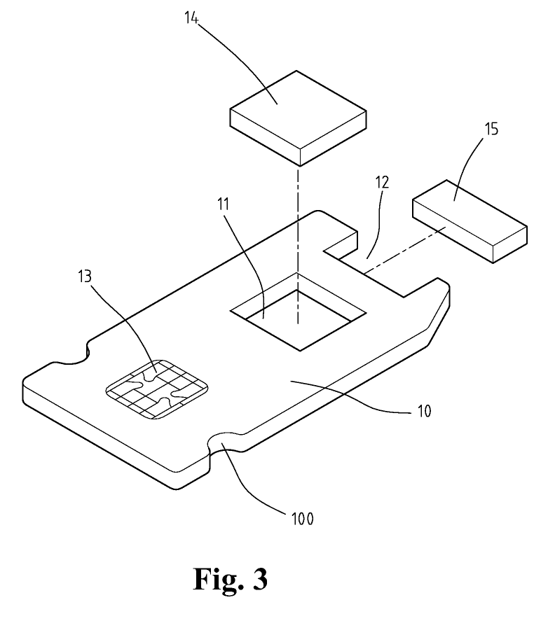

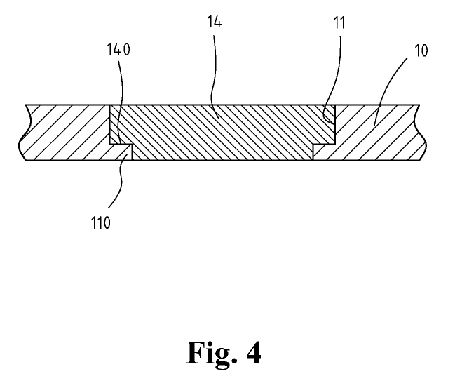

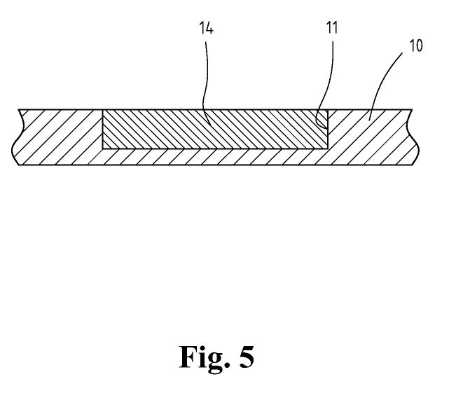

With reference to FIGS. 2, 3, 4, 5 and 6, a subscriber identity module (SIM) card in accordance with the present invention comprises a carrier (10), a SIM (13), an expansion module (14) and an optional antenna module (15).

The carrier (10) is a plastic card and comprises an expansion module recess (11) and an optional antenna recess (12). The plastic card has a top surface, two side edges, a front end, a rear end and two notches (100). The notches (100) are formed respectively in the side edges near the rear end so a person can grip and remove or insert the SIM card from an electronic device easily.

The expansion module recess (11) is formed in the top surface of the plastic card between the side edges near the front end, has four edges and an optional seat (110) and may completely penetrate the plastic card. The seat (110) protrudes in from the edges.

The antenna recess (12) is formed in the front end of the plastic card.

The SIM (13) is mounted on the top surface of the plastic card near the rear end between the notches (100).

The expansion module (14) is mounted in the expansion module recess (11), is connected to the SIM (13), has a top surface, a bottom surface, four edges and an optional mounting recess (140) and may comprise a memory chip, a wireless chip or a contact chip. The top surface is flush with the top surface of the plastic card when the expansion module (14) is mounted in the expansion module recess (11). The mounting recess (140) is formed in the bottom surface around the edges and corresponds to and is mounted against the seat (110) of the expansion module recess (11).

The memory chip on the expansion module (14) provides expanded memory.

The wireless chip on the expansion module (14) allows the SIM card to be used in an access control system.

The contact chip on the expansion module (14) allows the SIM card to access a second cell phone number so a person can use two cell phone numbers in one cell phone.

The antenna module (15) is mounted in the antenna recess (12) of the carrier (10) and may be an RF antenna to transmit and receive at 13.5 MHz or 2.4 GHz to accommodate other electronic devices.

What is claimed is:

1. A subscriber identity module (SIM) card comprising
a carrier being a plastic card having a top surface, two side edges, a front end, a rear end and two notches being formed respectively in the side edges near the rear end, and the carrier comprising an expansion module recess being formed in the top surface of the plastic card between the side edges near the front end and having four edges;
a SIM being mounted on the top surface of the plastic card near the rear end between the notches; and
an expansion module being mounted in the expansion module recess, being connected to the SIM and having
a top surface being flush with the top surface of the plastic card when the expansion module is mounted in the expansion module recess;
a bottom surface; and
four edges.

2. The SIM card as claimed as claim 1, wherein the expansion module recess further has a seat protruding in from the edges.

3. The SIM card as claimed as claim 1, wherein the carrier further comprises an antenna recess being formed in the front end of the plastic card.

4. The SIM card as claimed as claim 1, wherein the expansion module recess completely penetrates the plastic card.

5. The SIM card as claimed as claim 1, wherein the expansion module comprises a memory chip.

6. The SIM card as claimed as claim 1, wherein the expansion module comprises a wireless chip.

7. The SIM card as claimed as claim 1, wherein the expansion module comprises a contact chip.

8. The SIM card as claimed as claim 2, wherein the expansion module has a mounting recess being formed in the bottom surface around the edges of the expansion module and corresponding to and being mounted against the seat of the expansion module recess.

9. The SIM card as claimed as claim 3 further comprises an antenna module being mounted in the antenna recess.

10. The SIM card as claimed as claim 9, wherein the antenna module is an RF antenna.

11. The SIM card as claimed as claim 10, wherein the antenna module transmits and receives at 13.5 MHz.

12. The SIM card as claimed as claim 10, wherein the antenna module transmits and receives at 2.4 GHz.
